(19) United States
(12) Patent Application Publication
(10) Pub. No.: US 2026/0080076 A1
(43) Pub. Date: Mar. 19, 2026

(54) METHOD AND SYSTEM FOR METADATA CLASSIFICATION FOR ENTERPRISE DATA LAKES

(71) Applicant: JPMorgan Chase Bank, N.A., New York, NY (US)

(72) Inventors: John BUFORD, Somerset, NJ (US); Jialei SHI, London (GB); Zefang LIU, Mountain View, CA (US); Tatiana BADARACCO, Caba (AR); Iqbaljot WALIA, Hoboken, NJ (US); HP BUNAES, Fishers Island, NY (US); Valli MUSTI, Scarsdale, NY (US); Chirag VORA, Garnet Valley, PA (US); Johnathan Seungtae RA, Ridgewood, NJ (US); Anupam SHANDILYA, Newark, DE (US)

(73) Assignee: JPMorgan Chase Bank, N.A., New York, NY (US)

(21) Appl. No.: 18/887,758

(22) Filed: Sep. 17, 2024

(51) Int. Cl. G06F 21/60; G06F 16/23

(52) U.S. Cl. CPC G06F 21/604; G06F 16/2365; G06F 2221/2113; G06F 2221/2141

(57) ABSTRACT

Various methods and processes, apparatuses or systems, and media for automatically assigning metadata values to data elements within a data lake catalog in an accurate and efficient manner are disclosed. The method includes: receiving a first data set that includes a plurality of data elements; using a first classification model to assign, to each data element, respective first metadata that includes a respective global classifier, a respective confidentiality sub-class classifier and a sensitivity classifier; determining, for each data element based on the corresponding global classifier and the corresponding confidentiality sub-class classifier, a respective confidence threshold; determining, for each data element based on the corresponding confidence threshold and the corresponding sensitivity classifier, a respective consistency value; and applying, to each data element, at least one data guardrail to check whether the data element is consistent with the assigned metadata.

### TECHNICAL FIELD

This disclosure relates to methods and apparatuses for automatically assigning metadata values, such as access class values and sensitivity values, to data elements within a data lake catalog in an accurate and efficient manner.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Many large organizations use data lakes to store and access data used in information systems at scale. Data lakes provide an ability to share data across enterprise use cases. A data lake catalog is a construct for organizing metadata for operations, including validating access to data sets or data elements and discovering data sets and data elements using search. For access control, the catalog stores the classifications of each data set and each data element. When an access to a data set or data element is attempted, the access rights of the agent performing the access are compared with the classification attributes in the catalog.

The data lake data catalog may suffer from incomplete, sub-optimal, and inaccurate metadata. In particular, accurate access class values and sensitivity class values for data elements and data sets is necessary to prevent data leakage to a lower classification or sensitivity level environment. Additionally, discovery is enhanced by accurate descriptions.

A common issue is overclassification for access and sensitivity. Another common issue is the use of naming conventions that use undocumented acronyms and abbreviations. Another common issue is re-use of physical layer storage names as application layer or logical layer names of data elements. Another common issue is naming convention variations. Another common issue is the use of acronyms that have multiple disparate mappings.

Manual resolution of data catalog attribute inaccuracies is time consuming and subject to error. Manual classification may lead to data classifications assigned at a coarser grain than optimal to describe the underlying data. This forces overclassification when, for example, a single sensitive attribute requires that an entire table or a database be classified as sensitive.

The use of third-party systems and/or platforms, such as vendor systems, also may lead to security issues, integrity issues, and unnecessary system resource usage issues. For example, the use of third-party systems may increase the risk of inconsistencies in naming conventions, physical layer storage names, and acronyms having multiple disparate mappings, thereby leading to an increase in the likelihood of errors. Moreover, the use of multiple external systems may entail large system resource usage requirements, due to the need to receive, process, and transfer data among such systems. In addition, the use of third-party systems may give rise to a reduction in computer functionality resulting from unintegrated software.

Accordingly, there is a need for a mechanism for automatically assigning metadata values, such as access class values and sensitivity values, to data elements within a data lake catalog in an accurate and efficient manner.

### SUMMARY

The present disclosure, through one or more of its various aspects, embodiments, and/or specific features or sub-components, provides, among other features, various systems, servers, devices, methods, media, programs, and platforms for automatically assigning metadata values, such as access class values and sensitivity values, to data elements within a data lake catalog in an accurate and efficient manner.

According to an aspect of the present disclosure, a method for automatically assigning metadata values to data elements within a data lake catalog is provided. The method may be implemented by at least one processor. The method includes: receiving a first data set that includes a plurality of data elements; using a first classification model to assign, to each respective data element from among the plurality of data elements, respective first metadata that includes a respective global classifier, a respective confidentiality sub-class classifier and a respective sensitivity classifier; determining, for each respective data element based on the respective global classifier and the respective confidentiality sub-class classifier, a respective confidence threshold; determining, for each respective data element based on the respective confidence threshold and the respective sensitivity classifier, a respective consistency value; and applying, to each respective data element, at least one data guardrail to check whether the respective data element is consistent with the assigned metadata. When the respective data element is not consistent with the assigned metadata, the method may further include automatically enhancing the metadata by performing at least one from among an acronym expansion that relates to the respective data element, a description enrichment that relates to the respective data element, and a description generation that relates to the respective data element.

Each data element may include an identifier, a short name, an expanded name, and a description.

At least one data element may further include at least one attribute from among an information system name that references, uses, produces, or consumes the data element; a link to a related ontology; a link to a related vocabulary; and a business context attribute.

The global classifier may include at least one from among a highly confidential classification, a confidential classification, an internal classification, and a public classification.

The confidentiality sub-class classifier may include at least one from among biographical data that relates to a first predetermined access restriction and location data that relates to a second predetermined access restriction.

The sensitivity classifier may include at least one from among a personally identifiable information classification, a demographically identifiable information classification, and a government identification classification.

The data guardrail may include at least one from among a pattern matching algorithm that is designed to detect personally identifiable information, a data type inference algorithm that is designed to use a column name and a data property to determine a data type, a Kolmogorov-Smirnov test, and a predetermined set of business rules.

The method may further include: using a second classification model to assign, to each data element, respective second metadata; comparing, for each data element, the assigned first metadata with the assigned second metadata; and performing a mutual validation operation based on a result of the comparing.

The first model may include at least one from among a supervised machine learning model, a large language model, and an ensemble model.

According to another embodiment, a computing apparatus for automatically assigning metadata values to data elements within a data lake catalog is provided. The computing apparatus includes a processor; a memory; and a communication interface coupled to each of the processor and the memory. The processor may be configured to: receive, via the communication interface, a first data set that includes a plurality of data elements; use a first classification model to assign, to each respective data element from among the plurality of data elements, respective first metadata that includes a respective global classifier, a respective confidentiality sub-class classifier and a respective sensitivity classifier; determine, for each respective data element based on the respective global classifier and the respective confidentiality sub-class classifier, a respective confidence threshold; determine, for each respective data element based on the respective confidence threshold and the respective sensitivity classifier, a respective consistency value; and apply, to each respective data element, at least one data guardrail to check whether the respective data element is consistent with the assigned metadata. When the respective data element is not consistent with the assigned metadata, the processor may be further configured to automatically enhance the metadata by performing at least one from among an acronym expansion that relates to the respective data element, a description enrichment that relates to the respective data element, and a description generation that relates to the respective data element.

Each data element may include an identifier, a short name, an expanded name, and a description.

At least one data element may further include at least one attribute from among an information system name that references, uses, produces, or consumes the data element; a link to a related ontology; a link to a related vocabulary; and a business context attribute.

The global classifier may include at least one from among a highly confidential classification, a confidential classification, an internal classification, and a public classification.

The confidentiality sub-class classifier may include at least one from among biographical data that relates to a first predetermined access restriction and location data that relates to a second predetermined access restriction.

The sensitivity classifier may include at least one from among a personally identifiable information classification, a demographically identifiable information classification, and a government identification classification.

The data guardrail may include at least one from among a pattern matching algorithm that is designed to detect personally identifiable information, a data type inference algorithm that is designed to use a column name and a data property to determine a data type, a Kolmogorov-Smirnov test, and a predetermined set of business rules.

The processor may be further configured to: use a second classification model to assign, to each data element, respective second metadata; compare, for each data element, the assigned first metadata with the assigned second metadata; and perform a mutual validation operation based on a result of the comparing.

The first model may include at least one from among a supervised machine learning model, a large language model, and an ensemble model.

According to yet another embodiment, a non-transitory computer readable storage medium storing instructions for automatically assigning metadata values to data elements within a data lake catalog is provided. The storage medium includes a set of executable code which, when executed by a processor, causes the processor to: receive a first data set that includes a plurality of data elements; use a first classification model to assign, to each respective data element from among the plurality of data elements, respective first metadata that includes a respective global classifier, a respective confidentiality sub-class classifier and a respective sensitivity classifier; determine, for each respective data element based on the respective global classifier and the respective confidentiality sub-class classifier, a respective confidence threshold; determine, for each respective data element based on the respective confidence threshold and the respective sensitivity classifier, a respective consistency value; and apply, to each respective data element, at least one data guardrail to check whether the respective data element is consistent with the assigned metadata. When the respective data element is not consistent with the assigned metadata, the executable code may further cause the processor to automatically enhance the metadata by performing at least one from among an acronym expansion that relates to the respective data element, a description enrichment that relates to the respective data element, and a description generation that relates to the respective data element.

Each data element may include an identifier, a short name, an expanded name, and a description.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for automatically assigning metadata values to data elements within a data lake catalog in an accurate and efficient manner, in accordance with an embodiment.

FIG. 2 illustrates an exemplary diagram of a network environment with a device for automatically assigning metadata values to data elements within a data lake catalog in an accurate and efficient manner, in accordance with an embodiment.

FIG. 3 illustrates a system diagram for implementing a method for automatically assigning metadata values to data elements within a data lake catalog in an accurate and efficient manner, in accordance with an embodiment.

FIG. 4 illustrates an exemplary flow chart of a process for automatically assigning metadata values to data elements within a data lake catalog in an accurate and efficient manner, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As disclosed herein, a system or method improves security, reduces system errors due to heterogeneous third-party systems, and facilitates a more efficient use of system resources. In particular, the system or method mitigates the risk of inconsistencies in naming conventions, physical layer storage names, and acronyms having multiple disparate mappings, which would thereby lead to an increase in the likelihood of errors, by automatically assigning metadata values to data elements within a data lake catalog. Upon receiving a first data set that includes a plurality of data elements, the system uses a first classification model to assign, to each data element, respective first metadata that includes a respective global classifier, a respective confidentiality sub-class classifier and a respective sensitivity classifier. The system then determines a respective confidence threshold for each data element based on the corresponding global classifier and the corresponding confidentiality sub-class classifier. The system uses the corresponding confidence threshold and the corresponding sensitivity classifier to determine a respective consistency value. The system then applies data guardrails to each respective data element in order to check whether the data element is consistent with the assigned metadata. In this manner, the system is able to improve security, reduce system errors due to heterogeneous third-party systems, and facilitate a more efficient use of system resources by performing each of the above steps in a secure and easy-to-use single platform, without a reliance upon multiple third-party systems.

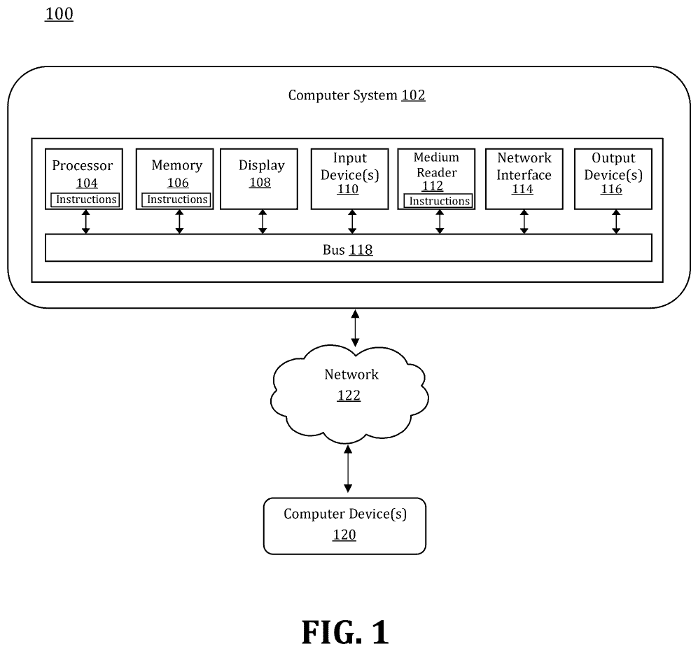

FIG. 1 is an exemplary system 100 for use in implementing a method for automatically assigning metadata values to data elements within a data lake catalog in an accurate and efficient manner, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain't Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

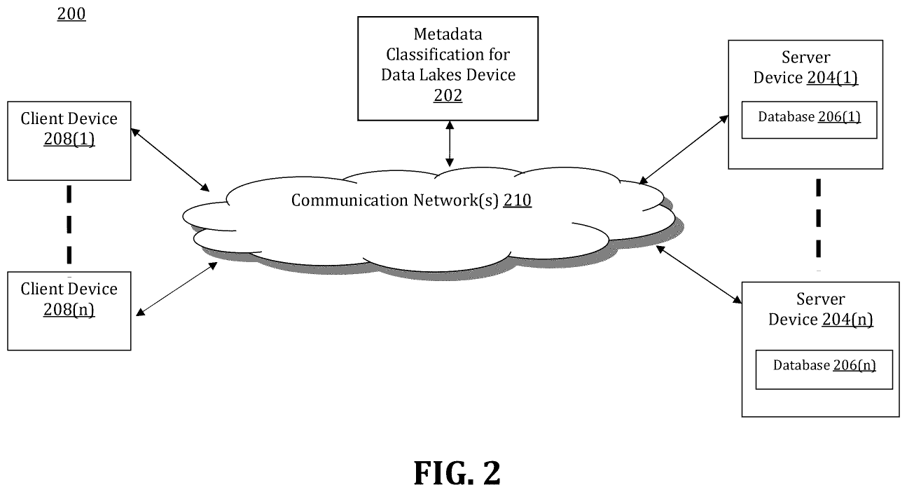

Referring to FIG. 2, a schematic of an exemplary network environment 200 for implementing a metadata classification for data lakes device (MCDLD) of the instant disclosure is illustrated.

In some embodiments, the above-described problems associated with conventional tools may be overcome by implementing an MCDLD 202 as illustrated in FIG. 2 that may be configured for implementing a method for automatically assigning metadata values to data elements within a data lake catalog in an accurate and efficient manner, but the disclosure is not limited thereto.

The MCDLD 202 may have one or more computer system 102s, as described with respect to FIG. 1, which in aggregate provide the necessary functions.

The MCDLD 202 may store one or more applications that can include executable instructions that, when executed by the MCDLD 202, cause the MCDLD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the MCDLD 202 itself, may be located in virtual server(s) running in a cloud-based computing environment rather than being tied to one or more specific physical network computing devices. Also, the application(s) may be running in one or more virtual machines (VMs) executing on the MCDLD 202. Additionally, in one or more embodiments of this technology, virtual machine(s) running on the MCDLD 202 may be managed or supervised by a hypervisor.

In the network environment 200 of FIG. 2, the MCDLD 202 is coupled to a plurality of server devices 204(1)-204(n) that hosts a plurality of databases 206(1)-206(n), and also to a plurality of client devices 208(1)-208(n) via communication network(s) 210. A communication interface of the MCDLD 202, such as the network interface 114 of the computer system 102 of FIG. 1, operatively couples and communicates between the MCDLD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the MCDLD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The MCDLD 202 may be a standalone device or integrated with one or more other devices or apparatuses, such as one or more of the server devices 204(1)-204(n), for example. In one particular example, the MCDLD 202 may be hosted by one of the server devices 204(1)-204(n), and other arrangements are also possible. Moreover, one or more of the devices of the MCDLD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the MCDLD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the MCDLD 202 that may efficiently provide a platform for implementing a method for automatically assigning metadata values to data elements within a data lake catalog in an accurate and efficient manner but the disclosure is not limited thereto.

The client devices 208(1)-208(n) may run interface applications, such as standard web browsers or standalone client applications, which may provide an interface to communicate with the MCDLD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the MCDLD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the MCDLD 202, the server devices 204(1)-204(n), or the client devices 208(1)-208(n), for example, may be configured to operate as virtual instances on the same physical machine. For example, one or more of the MCDLD 202, the server devices 204(1)-204(n), or the client devices 208(1)-208(n) may operate on the same physical device rather than as separate devices communicating through communication network(s) 210. Additionally, there may be more or fewer MCDLDs 202, server devices 204(1)-204(n), or client devices 208(1)-208(n) than illustrated in FIG. 2. In some embodiments, the MCDLD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

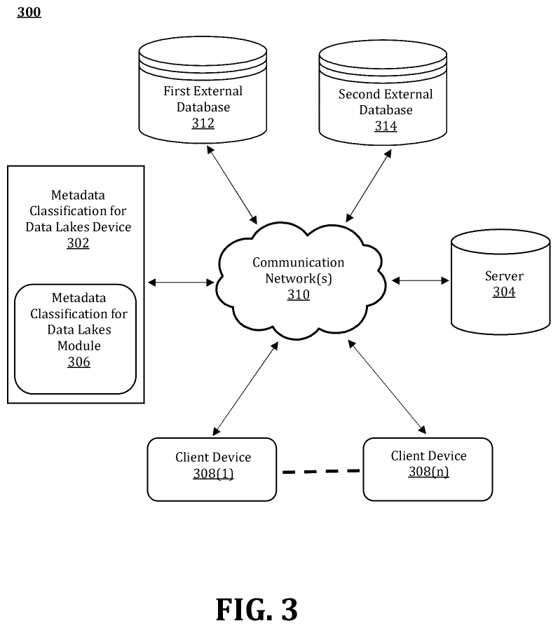

FIG. 3 illustrates a system diagram for implementing an MCDLD 302 having a metadata classification for data lakes module (MCDLM), in accordance with an embodiment.

As illustrated in FIG. 3, the system 300 may include an MCDLD 302 within which an MCDLM 306 is embedded, a server 304, a first external database 312, a second external database 314, a plurality of client devices 308(1) . . . 308(n), and a communication network 310.

In some embodiments, the MCDLD 302 including the MCDLM 306 may be connected to the server 304, and the database(s) 312 via the communication network 310. The MCDLD 302 may also be connected to the plurality of client devices 308(1) . . . 308(n) via the communication network 310, but the disclosure is not limited thereto.

In an embodiment, the MCDLD 302 is described and shown in FIG. 3 as including the MCDLM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the MCDLM 306 may be configured to receive real-time feed of data from the plurality of client devices 308(1) . . . 308(n) and secondary sources via the communication network 310.

As may be described below, the MCDLM 306 may be configured to: receive a first data set that includes a plurality of data elements; use a first classification model to assign, to each data element from among the plurality of data elements, respective first metadata that includes a respective global classifier, a respective confidentiality sub-class classifier and a sensitivity classifier; determine, for each data element based on the corresponding global classifier and the corresponding confidentiality sub-class classifier, a respective confidence threshold; determine, for each data element based on the corresponding confidence threshold and the corresponding sensitivity classifier, a respective consistency value; and apply, to each data element, at least one data guardrail to check whether the data element is consistent with the assigned metadata, but the disclosure is not limited thereto.

The plurality of client devices 308(1) . . . 308(n) are illustrated as being in communication with the MCDLD 302. In this regard, the plurality of client devices 308(1) . . . 308(n) may be “clients” (e.g., customers) of the MCDLD 302 and are described herein as such. Nevertheless, it is to be known and understood that the plurality of client devices 308(1) . . . 308(n) need not necessarily be “clients” of the MCDLD 302, or any entity described in association therewith herein. Any additional or alternative relationship may exist between either or both of the plurality of client devices 308(1) . . . 308(n) and the MCDLD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the MCDLD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The MCDLD 302 may be the same or similar to the MCDLD 202 as described with respect to FIG. 2, including any features or combination of features described with respect thereto.

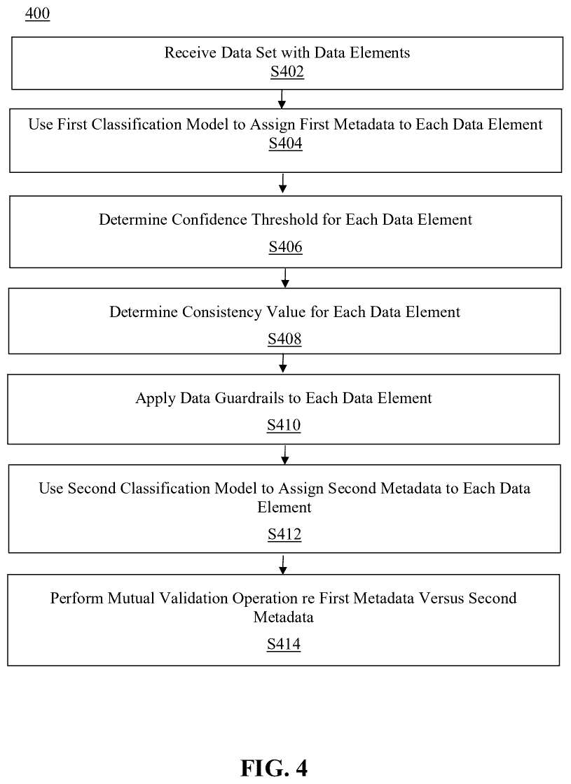

FIG. 4 illustrates an exemplary flow chart of a process 400 implemented by the MCDLM 306 of FIG. 3 for enablement of a system and a method for automatically assigning metadata values to data elements within a data lake catalog in an accurate and efficient manner, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include receiving a first data set that includes a plurality of data elements. In an embodiment, each data element may include an identifier, a short name, an expanded name, and a description, and some data elements may further include additional types of information. For example, a particular data element may further include at least one attribute from among an information system name that references, uses, produces, or consumes the particular data element; a link to a related ontology; a link to a related vocabulary; and a business context attribute. However, the present disclosure is not limited to these types of information; other types of information may also be included in any data element.

At step S404, the process 400 may include using a first classification model to assign respective first metadata to each respective data element included in the first data set and to generate a confidence score (also referred to herein as a “confidence value”), which refers to an estimate of a likelihood that an output of the first classification model is correct, thereby indicating a degree of confidence that the metadata assigned to a particular data element is accurate and complete with respect to that particular data element. In an embodiment, the confidence score may fall within a predetermined numerical range, such as, for example, a first range of [0, 1], a second range of [−1, +1], or a third range of [−∞, +∞]. In a circumstance by which the confidence score has a range of [0, 1], a determination that the confidence score is 0.4 may indicate that there is a relatively low likelihood that the metadata for a particular data element is accurate and complete, and therefore that an adjustment and/or enhancement to the metadata may be required; whereas a determination that the confidence score is 0.95 may indicate that there is a relatively high likelihood that the metadata for a particular data element is accurate and complete. In an embodiment, the first classification model is trained on labeled metadata that corresponds to the types of information included in each of the plurality of data elements, and as such, the first classification model is able to use the specific information included in a particular data element to generate first metadata for the particular data element. In an embodiment, the first classification model may include any one or more of a supervised machine learning (ML) model, a large language model (LLM), and/or an ensemble model. However, the present disclosure is not limited to these types of models, and other types of models may be used.

In an embodiment, for each respective data element, the first metadata may include a respective global classifier, a respective confidentiality sub-class classifier, and a sensitivity classifier. However, the present disclosure is not limited to these types of metadata, and other types of metadata may also be assigned to any one or more of the data elements. In an embodiment, the first metadata may also be enhanced by performing any one or more of an acronym expansion operation, a data element description generation operation, and/or a data element description enrichment operation, but the present disclosure is not limited thereto.

In an embodiment, the global classifier may include any one or more of a highly confidential classification, a confidential classification, an internal classification, and/or a public classification. However, the present disclosure is not limited to these types of classifications, and other types of classifications may also be included in the global classifier.

In an embodiment, the confidentiality sub-class classifier may include biographical data and/or location data. However, the present disclosure is not limited to these types of information, and other types of information may also be included in the confidentiality sub-class classifier.

In an embodiment, the sensitivity classifier may include any one or more of a personally identifiable information (PII) classification, a demographically identifiable information (DII) classification, and/or a government identification classification. However, the present disclosure is not limited to these types of sensitivity classifiers, and other types of sensitivity classifiers may also be assigned.

At step S406, the process 400 may include determining a respective confidence threshold for each data element. In an embodiment, the confidence threshold relates to how strict or how relaxed an enterprise wishes to be with respect to accepting or rejecting metadata assignments. In this aspect, a confidence threshold of zero implies that every metadata assignment made by the first classification model will be accepted, whereas higher confidence threshold values will tend to lower a recall of the metadata assignment while improving a precision thereof.

In an embodiment, the determination of the confidence threshold may be based on the corresponding global classifier and/or the corresponding confidentiality sub-class classifier, but the present disclosure is not limited thereto. For example, the confidence threshold may be determined using a precision-recall curve that allows an enterprise to choose a confidence threshold that achieves a desired precision. In this aspect, the selection of the confidence threshold may be based on a tradeoff between reducing a false positive rate (i.e., higher precision) and reducing a false negative rate (i.e., higher recall). As such, the selection of the confidence threshold may be based on business policy and/or data analysis. In addition, the confidence threshold may be used in various ways that may depend on business policy with respect to automation and/or data protection. For example, in the process 400, when the confidence score exceeds the confidence threshold, the process 400 may proceed to step S408, whereas when the confidence score falls below the confidence threshold, the first metadata assigned in step S404 may be changed to a next more conservative class by which the confidence score increases, or, depending on the value of the confidence score, the first metadata may remain unchanged and a business rule may be applied to the first metadata and the corresponding confidence score.

At step S408, the process 400 may include determining a respective consistency value for each data element. In an embodiment, the consistency value refers to a numerical value that indicates a degree of consistency among other relevant classifications included in a global data catalog. In this aspect, a relevance of a particular classification may be determined by any one or more of a metadata cluster analysis, textual similarity of data element names, common metadata values, and/or any other suitable technique. In an embodiment, the determination of the consistency value may be based on the corresponding confidence threshold and/or the corresponding sensitivity classifier, but the present disclosure is not limited thereto. For example, if the global data catalog includes ten data sets that each have a data element labeled “Account_Number” and each is classified as “Confidential,” and a data element from within the first data set has a data element with the same “Account_Number” label but is classified as “Public,” then a relatively low consistency score would be determined for this data element at step S408.

At step S410, the process 400 may include applying one or more data guardrails to each respective data element, in order to check whether the respective data element is consistent with the corresponding metadata that has been assigned thereto. In an embodiment, the applicable data guardrails may include any one or more of a pattern matching algorithm that is designed to detect personally identifiable information, a data type inference algorithm that is designed to use a column name and a data property to determine a data type, a Kolmogorov-Smirnov test, and a predetermined set of business rules. However, the present disclosure is not limited to these types of data guardrails, and other types of data guardrails may be applied to the data elements.

At step S412, the process 400 may include using a second classification model to assign respective second metadata to each respective data element. Then, at step S414, the process 400 may include performing a mutual validation operation as between the first metadata and the second metadata by comparing, for each data element, the assigned first metadata with the assigned second metadata, and then using a result of the comparison to determine whether or not either or both of the first metadata and the second metadata are valid. In this aspect, the use of the second classification model provides a capability to independently generate metadata for a particular data element, and the mutuality of the validation is manifested by whether the first metadata matches the second metadata, in which case the first metadata may be determined as being valid, or whether there is mismatch, in which case both the first and second metadata may be determined as requiring adjustment and/or enhancement.

In some embodiments as disclosed above in FIGS. 1-4, technical improvements effected by the instant disclosure may include a platform for implementing a metadata classification for data lakes module configured for enablement of automatically assigning metadata values to data elements within a data lake catalog in an accurate and efficient manner, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for automatically assigning metadata values to data elements within a data lake catalog, the method being implemented by at least one processor, the method comprising:
receiving a first data set that includes a plurality of data elements;
using a first classification model to assign, to each respective data element from among the plurality of data elements, respective first metadata that includes a respective global classifier, a respective confidentiality sub-class classifier and a respective sensitivity classifier;
determining, for each respective data element based on the respective global classifier and the respective confidentiality sub-class classifier, a respective confidence threshold;
determining, for each respective data element based on the respective confidence threshold and the respective sensitivity classifier, a respective consistency value; and
applying, to each respective data element, at least one data guardrail to check whether the respective data element is consistent with the assigned metadata,
wherein when the respective data element is not consistent with the assigned metadata, the method further comprises automatically enhancing the metadata by performing at least one from among an acronym expansion that relates to the respective data element, a description enrichment that relates to the respective data element, and a description generation that relates to the respective data element.

2. The method of claim 1, wherein each data element includes an identifier, a short name, an expanded name, and a description.

3. The method of claim 2, wherein at least one data element further includes at least one attribute from among an information system name that references, uses, produces, or consumes the data element; a link to a related ontology; a link to a related vocabulary; and a business context attribute.

4. The method of claim 1, wherein the global classifier includes at least one from among a highly confidential classification, a confidential classification, an internal classification, and a public classification.

5. The method of claim 1, wherein the confidentiality sub-class classifier comprises at least one from among biographical data that relates to a first predetermined access restriction and location data that relates to a second predetermined access restriction.

6. The method of claim 1, wherein the sensitivity classifier includes at least one from among a personally identifiable information classification, a demographically identifiable information classification, and a government identification classification.

7. The method of claim 1, wherein the data guardrail includes at least one from among a pattern matching algorithm that is designed to detect personally identifiable information, a data type inference algorithm that is designed to use a column name and a data property to determine a data type, a Kolmogorov-Smirnov test, and a predetermined set of business rules.

8. The method of claim 1, further comprising:
using a second classification model to assign, to each data element, respective second metadata;
comparing, for each data element, the assigned first metadata with the assigned second metadata; and
performing a mutual validation operation based on a result of the comparing.

9. The method of claim 1, wherein the first model comprises at least one from among a supervised machine learning model, a large language model, and an ensemble model.

10. A computing apparatus for automatically assigning metadata values to data elements within a data lake catalog, the computing apparatus comprising:
a processor;
a memory; and
a communication interface coupled to each of the processor and the memory,
wherein the processor is configured to:
receive, via the communication interface, a first data set that includes a plurality of data elements;
use a first classification model to assign, to each respective data element from among the plurality of data elements, respective first metadata that includes a respective global classifier, a respective confidentiality sub-class classifier and a respective sensitivity classifier;
determine, for each respective data element based on the respective global classifier and the respective confidentiality sub-class classifier, a respective confidence threshold;
determine, for each respective data element based on the respective confidence threshold and the respective sensitivity classifier, a respective consistency value; and
apply, to each respective data element, at least one data guardrail to check whether the respective data element is consistent with the assigned metadata,
wherein when the respective data element is not consistent with the assigned metadata, the processor is further configured to automatically enhance the metadata by performing at least one from among an acronym expansion that relates to the respective data element, a description enrichment that relates to the respective data element, and a description generation that relates to the respective data element.

11. The computing apparatus of claim 10, wherein each data element includes an identifier, a short name, an expanded name, and a description.

12. The computing apparatus of claim 11, wherein at least one data element further includes at least one attribute from among an information system name that references, uses, produces, or consumes the data element; a link to a related ontology; a link to a related vocabulary; and a business context attribute.

13. The computing apparatus of claim 10, wherein the global classifier includes at least one from among a highly confidential classification, a confidential classification, an internal classification, and a public classification.

14. The computing apparatus of claim 10, wherein the confidentiality sub-class classifier comprises at least one from among biographical data that relates to a first predetermined access restriction and location data that relates to a second predetermined access restriction.

15. The computing apparatus of claim 10, wherein the sensitivity classifier includes at least one from among a personally identifiable information classification, a demographically identifiable information classification, and a government identification classification.

16. The computing apparatus of claim 10, wherein the data guardrail includes at least one from among a pattern matching algorithm that is designed to detect personally identifiable information, a data type inference algorithm that is designed to use a column name and a data property to determine a data type, a Kolmogorov-Smirnov test, and a predetermined set of business rules.

17. The computing apparatus of claim 10, wherein the processor is further configured to:
use a second classification model to assign, to each data element, respective second metadata;
compare, for each data element, the assigned first metadata with the assigned second metadata; and
perform a mutual validation operation based on a result of the comparing.

18. The computing apparatus of claim 10, wherein the first model comprises at least one from among a supervised machine learning model, a large language model, and an ensemble model.

19. A non-transitory computer readable storage medium storing instructions for automatically assigning metadata values to data elements within a data lake catalog, the storage medium comprising executable code which, when executed by a processor, causes the processor to:
receive a first data set that includes a plurality of data elements;
use a first classification model to assign, to each respective data element from among the plurality of data elements, respective first metadata that includes a respective global classifier, a respective confidentiality sub-class classifier and a respective sensitivity classifier;
determine, for each respective data element based on the respective global classifier and the respective confidentiality sub-class classifier, a respective confidence threshold;
determine, for each respective data element based on the respective confidence threshold and the respective sensitivity classifier, a respective consistency value; and
apply, to each respective data element, at least one data guardrail to check whether the respective data element is consistent with the assigned metadata,
wherein when the respective data element is not consistent with the assigned metadata, the executable code further causes the processor to automatically enhance the metadata by performing at least one from among an acronym expansion that relates to the respective data element, a description enrichment that relates to the respective data element, and a description generation that relates to the respective data element.

20. The storage medium of claim 19, wherein each data element includes an identifier, a short name, an expanded name, and a description.
